(19) United States
(12) Patent Application Publication
(10) Pub. No.: US 2010/0059984 A1
(43) Pub. Date: Mar. 11, 2010

(54) Document Authentication Using Security Ink and Chemical Reactant

(75) Inventors: JoAnn Domanski, Kennett Square, PA (US); Richard J. Selah, Newtown, PA (US)

Correspondence Address: WEITZMAN LAW OFFICES, LLC, 425 EAGLE ROCK AVENUE, SUITE 102, ROSELAND, NJ, 07068, US

(73) Assignee: NOCOPI TECHNOLOGIES, INC., West Conshohocken, PA (US)

(21) Appl. No.: 12/206,244

(22) Filed: Sep. 8, 2008

(51) Int. Cl. B42D 15/10; G09F 3/03

(52) U.S. Cl. 283/91; 283/95; 283/85

(57) ABSTRACT

A method and system of document authentication comprise applying a neutralizer security ink to a paper document to be authenticated, the neutralizer security ink neutralizing a reactant in the paper document. A color changing security ink is applied to the paper document to be authenticated at least to an area where the neutralizer security ink was applied, the color changing security ink having a first security color and a second security color. A test solution is applied to the paper document to be authenticated at least on the area where the neutralizer security ink and color changing security ink have both been applied. The application of the test solution to the area where the neutralizer security ink and color changing security ink have both been applied causes the color changing security ink to change from the first security color to the second security color.

### BACKGROUND

1. Field of the Invention

This disclosure relates generally to document authentication and, more particularly, to an improved method and system for authentication of documents using a combination of security ink and a chemical reactant.

2. Description of Related Art

Detection of counterfeit documents, including, but not limited to sales receipts, tickets, coupons and other value-based documents, is desirable to businesses, governments and other institutional bodies that rely on the authenticity of documentation. Counterfeiters copy original receipts, tickets, coupons, and other value-based documents, and use these counterfeit copies to defraud businesses and consumers of millions of dollars each year.

Various scams exist to take advantage of copying original receipts and other paper based items of value. For example, after legitimately purchasing a product from a retailer, a counterfeiter may copy the authentic sales receipt multiple times. The counterfeiter will then return to the store with the counterfeit receipt, pick up another originally purchased product and “return” that product using the counterfeit receipt.

To prevent this, many retailers and gaming houses currently use sales receipts that contain a unique barcode that will only allow one return per receipt. Instead of “returning” the product using the counterfeit sales receipt, counterfeiters circumvent this security feature by simply walking out of the business establishment with the product identified in the counterfeit sales receipt, which is later “fenced” on Internet auction sites or at flea markets. If the counterfeiter is stopped leaving the store with the stolen goods, the counterfeiter uses the counterfeit sales receipt as proof that the product was never returned.

A number of security inks, both covert and overt, have been developed to deter counterfeiters, but there is still a need for a security ink to protect value-based paper documents that cannot be copied and is readily identifiable as an authentic document.

### BRIEF SUMMARY

In a first aspect of the present disclosure, a method and system of document authentication comprise applying a neutralizer security ink to a paper document to be authenticated, the neutralizer security ink neutralizing a reactant in the paper document. A test solution is applied to at least a first area on the paper document to be authenticated where the neutralizer security ink has been applied. The application of the test solution to the first area results in no color change in the first area due to the neutralization of the reactant in the paper document. The application of the test solution to a second area where neutralizer security ink has not been applied results in color change in the second area due to a chemical reaction between the reactant and at least one component of the test solution.

In a second aspect of the present disclosure, a method and system of document authentication comprise applying a neutralizer security ink to a paper document to be authenticated, the neutralizer security ink neutralizing a reactant in the paper document. A color changing security ink is applied to the paper document to be authenticated at least to an area where the neutralizer security ink was applied, the color changing security ink having a first security color and a second security color. A test solution is applied to the paper document to be authenticated at least on the area where the neutralizer security ink and color changing security ink have both been applied. The application of the test solution to the area where the neutralizer security ink and color changing security ink have both been applied causes the color changing security ink to change from the first security color to the second security color.

In a third aspect of the present disclosure, a method of document authentication comprises applying a color changing security ink to a paper document to be authenticated. The paper document has a coating. The color changing security ink has a first security color and a second security color. A test solution is applied to the paper document to be authenticated. The paper document is identified as authentic when the application of the test solution to the area where the color changing security ink has been applied causes the color changing security ink to change from the first security color to the second security color.

The foregoing has outlined rather generally the features and technical advantages of one or more embodiments of this disclosure in order that the following detailed description may be better understood. Additional features and advantages of this disclosure will be described hereinafter, which may form the subject of the claims of this application.

### BRIEF DESCRIPTION OF THE DRAWING

This disclosure is further described in the detailed description that follows, with reference to the drawings, in which:

FIG. 1 is a representation of a paper document printed with a single security ink and treated with a test solution in accordance with one aspect of this disclosure;

FIG. 2 is a representation of a paper document printed with a two-part security ink and treated with an application of a test solution in accordance with another aspect of this disclosure;

FIG. 3 is a flow diagram illustrating a preferred sequence of steps for implementing a first security tier for document authentication; and

FIG. 4 is a flow diagram illustrating a preferred sequence of steps for implementing a second security tier for document authentication.

### DETAILED DESCRIPTION

A system, method and paper for document authentication are disclosed herein. The system, method and paper for document authentication may be utilized on documents for a variety of purposes, including (but not limited to) validation, security and/or anti-counterfeiting measures. Such documents may be, for example, original sales receipts, tickets, coupons or other value based paper documents.

In one preferred embodiment, the system, method, and paper for document authentication utilizes a two-tiered security system. The first tier comprises a neutralizer security ink that neutralizes a reactant in the paper document to be authenticated. The neutralizer security ink is preferably colorless and may be printed or otherwise applied to the paper document in a conventional manner, such as, for example, using a conventional flexographic printing press. A second tier or level of security may optionally be provided by printing or otherwise applying a color changing security ink to a portion of the paper containing the neutralizer security ink.

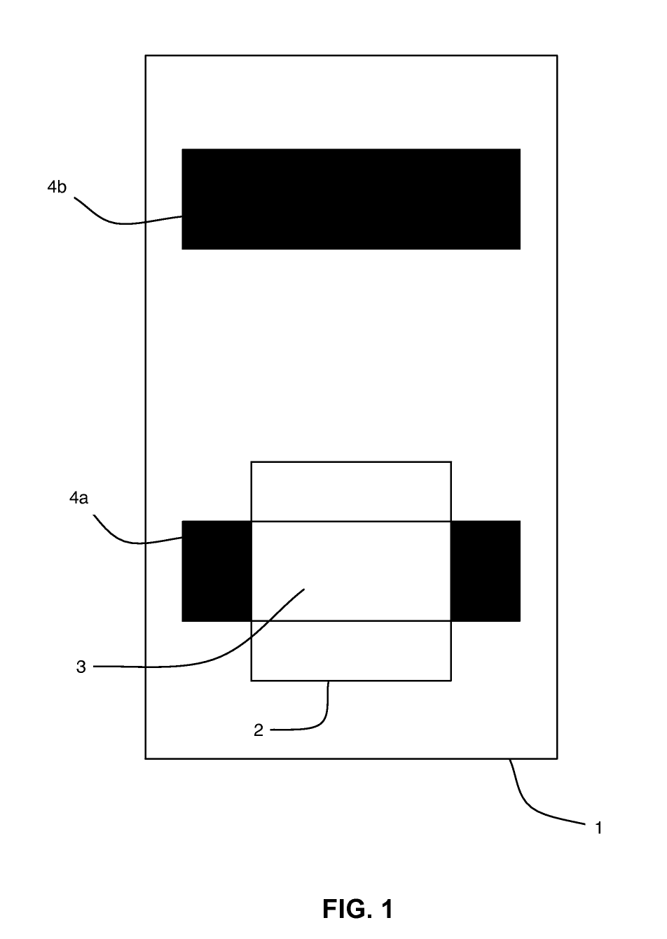

FIG. 1 illustrates the first tier of security provided by the system, method and paper for document authentication. Document or substrate 1 represents any typical paper value-based document, including (but not limited to) original sales receipts, coupons or event tickets. Document 1 is preferably printed on a common commercially available type of paper, such as, for example, Appleton Paper with a thermal grade of A400 or A800. Common commercially available paper typically contains starch, which is utilized herein as a chemical reactant for counterfeit detection. This preferred embodiment utilizes the presence of starch (or some other reactant) in the paper to generate a chemical reaction to identify whether the document is authentic or a counterfeit. This disclosure, however, is not limited specifically to any brand or grade of paper, nor is it limited to the use of starch as the primary chemical reactant in the paper. This disclosure is intended to encompass any brand, type or grade of paper and may also utilize any type of chemical reactant present within the paper selected.

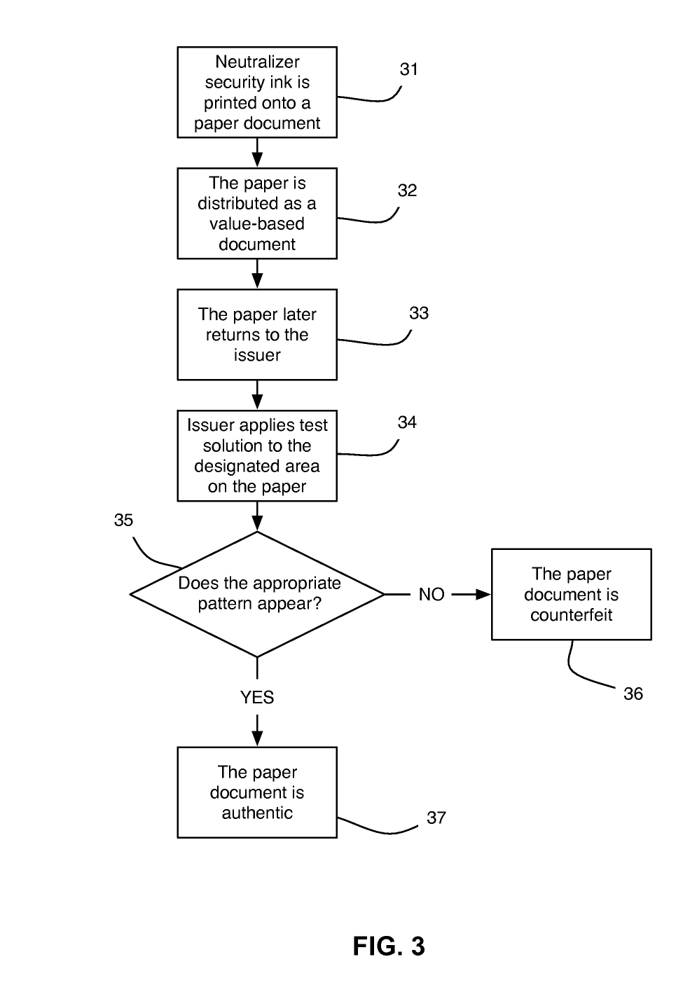

FIG. 3 is a flow chart illustrating the preferred sequence of steps for implementing the first security tier for the method and system for document authentication disclosed herein. Referring to FIGS. 1 and 3, a pattern 2 is preferably printed onto document 1 using neutralizer security ink in step 31. The neutralizer security ink neutralizes reactants (e.g., starch) in the paper document 1 where the neutralizer security ink comes in contact with the paper substrate. The neutralizer security ink is preferably colorless and may be applied using a conventional flexographic printing process. In an exemplary embodiment, a standard flexographic printing press with aniloxes between 100-800 lines and volume greater than 0 to 20 BCM is utilized. Each printing unit is preferably thoroughly washed and flushed with warm or hot water to insure all possible contaminants from previous inks are removed. Other printing or coating methods may also be used in accordance with this disclosure.

The neutralizer security ink preferably comprises at least one buffer agent, at least one binder agent and at least one surfactant. In one exemplary embodiment, the buffer agent preferably comprises potassium phosphate, sodium phosphate and sodium thiosulfate. The binder agent preferably comprises a commercially available hydroxyethylcellulose, such as Natrosol® 250 GR (sold by Hercules, Inc.), and water. The surfactant preferably comprises a commercially available surfactant, such as Surfynol® 104PG-50 (sold by Air Products and Chemicals, Inc.).

The following table sets forth the preferred weight percentage of the ingredients of the exemplary neutralizer security ink.

| INGREDIENT | % WEIGHT |
|---|---|
| Potassium Phosphate | 2.1 |
| Sodium Phosphate | 2.1 |
| Sodium Thiosulfate | 8.7 |
| Binder Agent | 1.7 |
| Surfactant | 0.5 |
| Water | 84.9 |

A suitable ultraviolet brightener or ultraviolet absorber may be added to the neutralizer security ink depending on the optical brightness characteristics of the paper substrate. The addition of ultraviolet properties to the neutralizer security ink confers additional advantages to utilization of the ink. The ultraviolet property may be used during printing to enable visual confirmation that the print pattern is satisfactory. The ultraviolet property may also be used as an additional security feature, as the ultraviolet-treated colorless neutralizer security ink may present a visible pattern when exposed to the appropriate ultraviolet conditions. Any suitable ultraviolet additive may be used, such as Leucophor® AC (sold by Clariant Corp.), which may preferably be added to the neutralizer security ink up to 2% of the final formulation.

In step 32, document 1 is distributed by the issuer as proof or representation of some value. Examples include (but are not limited to) the issuance of a receipt as proof of purchase of a store item, or the issuance of a ticket for a sporting event paid for with cash consideration. In step 33, document 1 returns to the issuer and is presented as proof of the previous exchange. Examples of this type of return may include (but are not limited to) the presentment of a proof of purchase receipt when a customer seeks to return a store-bought item, or the presentment of a ticket for entrance to a sporting event. The issuer may then check document 1 for authenticity.

In step 34, an issuer may authenticate document 1 by applying a counterfeit detection test solution to document 1, creating, for example, application areas 4a and/or 4b as illustrated in FIG. 1. The application area 4a covers at least some of the area containing the neutralizer security ink print pattern 2, creating an overlapping region 3 where the test solution is applied over the neutralizer security ink pattern. The test solution preferably includes a composition designed to interact with the reactant (e.g., starch) in the paper to create a detectible reaction. In the exemplary preferred embodiment, the test solution may be applied using a modified counterfeit currency detector marker containing iodine, such as Dri Mark® Smart Money® Counterfeit Detector Pen (sold by Dri Mark Products, Inc.). Iodine is a common chemical used to test for the presence of starch in paper products. When iodine comes into contact with starch, dark discoloration forms. This preferred embodiment, therefore, extends the utility of a conventional counterfeit currency detector by enabling the authentication of value-based documentation (using neutralizer security ink) while retaining the ability to authenticate currency.

Therefore, should the test solution be applied to the area 4b of the paper document 1, the area 4b will darken because of the chemical interaction between the iodine in the test solution and the starch in the paper document 1. In contrast, when the test solution is applied to the area 4a of the document where the neutralizer security ink (pattern 2) is applied, only part of the area 4a will darken in response to the chemical interaction between the iodine in the test solution and the starch in the paper document 1. The overlapping region 3 will not darken because the neutralizer security ink has neutralized the starch in the paper 1. This, in turn, provides the first tier of document authentication protection.

In step 35, the issuer may then determine whether the appropriate pattern of discoloration and non-discoloration has appeared. Only authentic documents printed with the neutralizer security ink will resist discoloration in the appropriate pattern when the test solution is applied to the designated print areas (e.g., area 3 in FIG. 1). Counterfeit documents printed with standard ink will darken in the designated areas upon application of the test solution. If application area 4a discolors entirely or in an incorrect pattern, then the issuer may determine that document 1 is counterfeit in step 36. In contrast, if application area 4a discolors in the expected pattern or does not discolor, then the issuer may determine that document 1 is original and authentic in step 37.

In addition, as mentioned above, an additional security feature for document authentication may be provided through the addition of a suitable ultraviolet brightener or ultraviolet absorber to the neutralizer security ink. The ultraviolet-treated colorless neutralizer security ink may present a visible pattern when exposed to the appropriate ultraviolet conditions. The presence of the visual pattern provides further confirmation that document 1 is original and authentic and the absence of the visible pattern provides further confirmation that document 1 is a counterfeit.

The print pattern may vary according to the needs of the user. Options available to the end-user include (but are not limited to) company names, logos, watermarks, printed text or special security patterns. For instance, the print pattern may be a simple square that reveals a square when test solution is applied and the area around the square darkens. More complicated patterns may also be used. For instance, the neutralized print area may reveal a name or logo upon application of test solution. The end-user may design the print patterns according to the end-user's own requirements.

It is understood that any combination of chemical reactants may be used, and that this disclosure is not limited to the use of iodine and starch as the principle mechanism for authentication. It is further understood that the test solution may be applied in a variety of ways, including (but not limited to) using a pen-like marker filled with the test solution, a dropper filled with the test solution, or a brush or applicator dipped in the test solution.

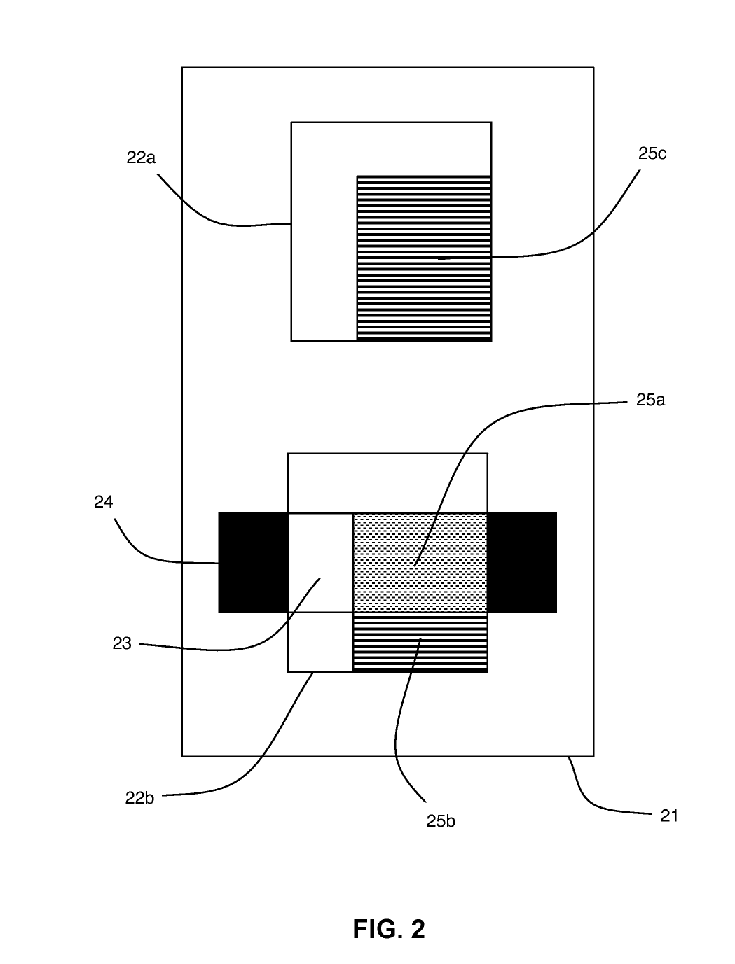

FIG. 2 illustrates an optional second tier of security that may be utilized in combination with the neutralizer security ink described above. The second security tier preferably comprises a document where a layer of color changing security ink is printed at least partially over an initial layer of printed neutralizer security ink. Document 21 is a paper document to be authenticated under the two-tier system for document authentication, and represents the same type of value-based document as document 1. Document 21 may be printed on the same types and grades of paper as document 1.

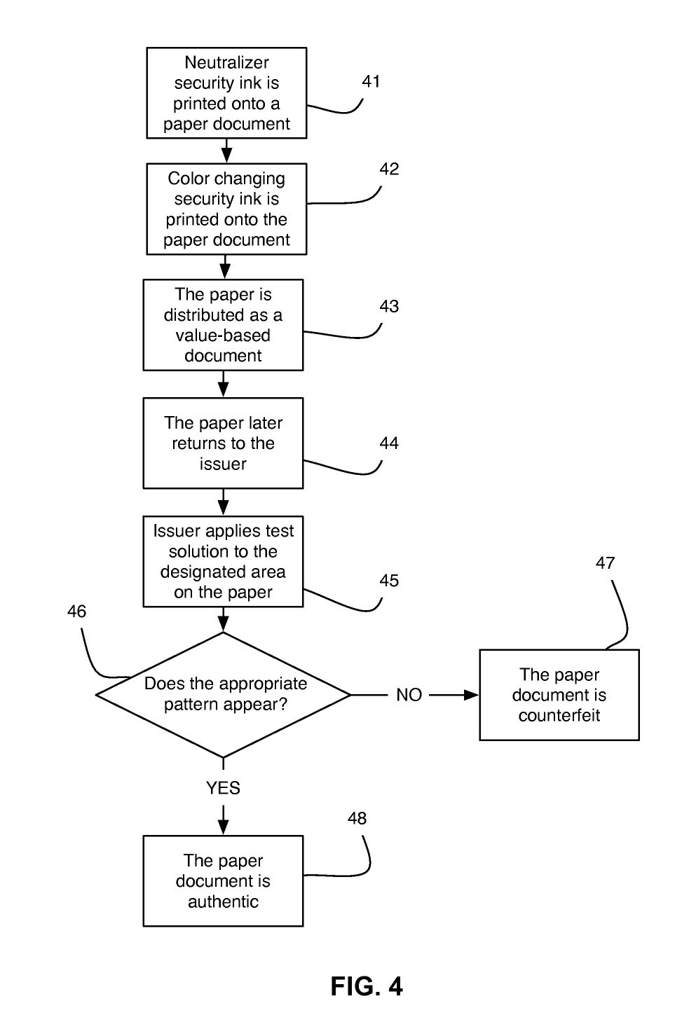

Referring now to FIG. 4, in step 41, neutralizer security ink is printed or otherwise applied onto document 21, forming, for example, print areas 22a and 22b. In step 42, color changing security ink is preferably printed or otherwise applied onto document 21, such that it at least partially overlays neutralizer security ink print areas 22a and 22b, thus creating overlapping areas 25a, 25b, and 25c. The color changing security ink preferably possesses two security colors. The first security color is represented by the striped pattern in areas 25b and 25c. The second security color is represented by the spotted pattern in area 25a. The color changing security ink is chemically formulated to change from the first security color to the second security color upon interaction with at least one other chemical. In this embodiment, the printing area for the color changing security ink covers at least some portions of neutralized areas 22a and 22b, creating an overlapping area 25a. The overlap is beneficial because neutralization of the reactants in the paper, such as starch, enables the color changing function of the color changing security ink.

The color changing security ink preferably comprises at least one dye agent, at least one binder agent, and at least one surfactant. In one exemplary embodiment, the dye preferably comprises bromocresol green and bromocresol green sodium salt. The binder agent preferably comprises a commercially available hydroxyethylcellulose, such as Natrosol® 250 GR (sold by Hercules Inc.). The surfactant preferably comprises a commercially available surfactant, such as Surfynol® 104PG-50 (sold by Air Products and Chemicals, Inc.). The balance of the color changing security ink is preferably comprised of at least isopropanol (isopropyl alcohol) and water.

The following table sets forth the preferred weight percentage of the ingredients of the exemplary color changing security ink.

| INGREDIENT | % WEIGHT |
|---|---|
| Bromocresol Green | 1.3 |
| Bromocresol Green Sodium Salt | 1.3 |
| Binder Agent | 1.7 |
| Surfactant | 0.5 |
| Isopropanol | 10.0 |
| Water | 85.2 |

The color changing security ink may be applied using a conventional flexographic printing process. In an exemplary embodiment, a standard flexographic printing press with aniloxes between 100-800 lines and volume of greater than 0 to 20 BCM is utilized. Each printing unit is preferably thoroughly washed and flushed with warm or hot water to insure all possible contaminants from previous inks are removed. Other printing or coating methods may also be used in accordance with this disclosure.

In step 43, document 21 is distributed by the issuer as proof of purchase or representation of some value. Examples include (but are not limited to) the issuance of a receipt as proof of purchase of a store item, or the issuance of a ticket for a sporting event for which a customer has paid value. In step 44, document 21 returns to the issuer and is presented as proof of the previous exchange. Examples of this type of return may include (but are not limited to) the presentment of a proof of purchase receipt when a customer seeks to return a store-bought item, or the presentment of a ticket for entrance to a sporting event. The issuer may then check document 21 for authenticity.

In step 45, the issuer may test document 21 for authenticity by applying the counterfeit detection test solution described above to paper document 21, creating, for example, marked area 24, which overlaps neutralized area 22b (containing the neutralizer security ink) and printed area 25a (containing the color changing security ink). A reaction between compositions in the test solution and compositions in the color changing security ink creates the color changing effect.

In this preferred embodiment, a reactant chemical, such as, for example, tartaric acid (C₄H₆O₆), is added to the counterfeit detection test solution to enable the color changing function of the color changing security ink. In one exemplary embodiment, approximately 1.5 grams of a mixture of 0.8 grams of tartaric acid and 50 grams of distilled water was added to the ink reservoir of a commercially available counterfeit currency detector marker containing iodine, such as Dri Mark® Smart Money® Counterfeit Detector Pen (sold by Dri Mark Products, Inc.). The counterfeit currency detector marker preferably retains its ability to detect counterfeit currency despite the addition of a reactant chemical (such as tartaric acid), thereby allowing an end-user to authenticate value-based documents and currency with a single test solution. It is understood that this disclosure is not limited to the use of tartaric acid and other chemicals may be used as appropriate.

The subsequent chemical reaction between the tartaric acid composition in the test solution and the composition in the color changing security ink causes the color changing security ink to change from the first security color (represented by the stripes) to the second security color (represented by the spots) in area 25a. In this preferred embodiment, the first security color is light blue, and the second security color is yellow. It is understood, however, that this disclosure is not limited to a color change from light blue to yellow, and that other dyes may be incorporated into the color changing security ink to effect other desired color changes.

In step 46, the issuer may examine the revealed security pattern to determine whether the document is authentic or counterfeit. For example, area 25a has changed color from the first security color (e.g., light blue) to the second security color (e.g., yellow), which may be indicative of an authentic document. Area 23 does not change color because the color changing security ink was not applied to it. Area 23 does, however, remain clear because of the neutralization of the reactants (e.g., starch) in paper document 21. The sides of area 24 discolor upon application of the test solution because the reactant (e.g., starch) in paper document 21 has not been neutralized by neutralizer security ink and chemically reacts with the iodine in the test solution. Area 25b retains the first security color (as represented by the striped lines) because the test solution was not applied to it. The totality of these effects or any one of them may be regarded as the two-tier security pattern that readily identifies a document as authentic or counterfeit.

This second tier, therefore, provides an additional layer of security in that only the proper print pattern of neutralizer security ink and color changing security ink can reveal the desired security pattern upon application of the test solution. If an incorrect security pattern is revealed, then the issuer may determine that document 21 is counterfeit in step 47. In contrast, if the appropriate security pattern is revealed, then the issuer may determine that document 21 is authentic in step 48.

In addition, as mentioned above, an additional security feature for document authentication may be provided through the addition of a suitable ultraviolet brightener or ultraviolet absorber to the neutralizer security ink. The ultraviolet-treated colorless neutralizer security ink may present a visible pattern in those areas not covered by the color changing security ink when exposed to the appropriate ultraviolet conditions. The presence of the visual pattern provides further confirmation that document 21 is original and authentic and the absence of the visible pattern provides further confirmation that document 21 is counterfeit.

It should be noted that the actual two-tier security pattern may vary according to the needs of the user. Options available to the end-user include (but are not limited to) company names, logos, watermarks, printed text or special security patterns. Furthermore, the print pattern of the color changing security ink does not need to duplicate the print pattern of the neutralizer security ink. The only areas where the color changing security ink and neutralizer security ink must overlap are those areas where a color change from the first security color to the second security color is desired. The end-user may utilize any combination of discoloration, neutralization, non-color change and color change to create the overall security pattern strategy for the user's specific security needs.

In an alternative preferred embodiment, the color changing security ink described above may be utilized without application of the neutralizer security ink on a document to be authenticated. In this embodiment, a layer of color changing security ink may be printed or otherwise applied directly on to a commercially available paper having a coating, such as, for example, a high gloss coat or varnish. Examples of available high gloss coat or varnished papers include (but are not limited to) Appleton POS Plus® or Kanzaki KIP-370®. The gloss coat or varnish functions as a barrier, which prevents chemicals from contacting reactants in the paper (such as starch), thereby enabling the color changing function of the color changing security ink.

In this embodiment, application of the test solution described above to the color changing security ink causes the color changing security ink to change color from the first security color to the second security color. When this occurs, the document is authenticated.

Having described and illustrated the principles of this application by reference to one or more preferred embodiments, it should be apparent that the preferred embodiment(s) may be modified in arrangement and detail without departing from the principles disclosed herein and that it is intended that the application be construed as including all such modifications and variations insofar as they come within the spirit and scope of the subject matter disclosed herein.

What is claimed is:

1. A method of document authentication, comprising:
applying a neutralizer security ink to a paper document to be authenticated, the neutralizer security ink neutralizing a reactant in the paper document;
applying a color changing security ink to the paper document to be authenticated at least to a portion of an area where the neutralizer security ink was applied, the color changing security ink having a first security color and a second security color;
applying a test solution to the paper document to be authenticated at least on the area where the neutralizer security ink and color changing security ink have both been applied; and
identifying the paper document as authentic when the application of the test solution to the area where the neutralizer security ink and color changing security ink have both been applied causes the color changing security ink to change from the first security color to the second security color.

2. The method according to claim 1, further comprising detecting an ultraviolet brightener in the neutralizer security ink as an indication of the authenticity of the document.

3. The method according to claim 2, wherein the ultra violet brightener is present in the neutralizer security ink in an amount of up to about 2% of the total weight of the neutralizer security ink.

4. The method according to claim 1, further comprising detecting an ultraviolet absorber in the neutralizer security ink as an indication of the authenticity of the document.

5. The method according to claim 1, wherein the neutralizer security ink comprises potassium phosphate.

6. The method according to claim 1, wherein the neutralizer security ink comprises sodium phosphate.

7. The method according to claim 1, wherein the neutralizer security ink comprises sodium thiosulfate.

8. The method according to claim 1, wherein the neutralizer security ink comprises a surfactant.

9. The method according to claim 1, wherein the neutralizer security ink comprises a binder agent.

10. The method according to claim 10, wherein the binder agent comprises hydroxyethyl cellulose.

11. The method according to claim 1, wherein the color changing security ink comprises bromocresol green.

12. The method according to claim 1, wherein the color changing security ink comprises bromocresol green sodium salt.

13. The method according to claim 1, wherein the color changing security ink comprises a surfactant.

14. The method according to claim 1, wherein the color changing security ink comprises a binder agent.

15. The method according to claim 14, wherein the binder agent for the color changing security ink comprises hydroxyethyl cellulose.

16. The method according to claim 1, wherein the color changing security ink comprises isopropanol.

17. The method according to claim 1, wherein the test solution comprises iodine and a reactant chemical that causes the color changing security ink to change from the first security color to the second security color.

18. The method according to claim 17, wherein the reactant chemical comprises tartaric acid.

19. The method according to claim 1, wherein the neutralizer security ink comprises about 2.1% potassium phosphate, 2.1% sodium phosphate, 8.7% sodium thiosulfate, 0.5% surfactant, 1.7% hydroxyethyl cellulose and 84.9% water by weight of the neutralizer security ink.

20. The method according to claim 1, wherein the color changing security ink comprises about 1.3% bromocresol green, 1.3% bromocresol green sodium salt, 0.5% surfactant, 1.7% hydroxyethyl cellulose, 10% isopropanol and 85.2% water by weight of the color changing security ink.

21. A method of document authentication, comprising:
applying a neutralizer security ink to a paper document to be authenticated, the neutralizer security ink neutralizing a reactant in the paper document; and
applying a test solution to at least a first area on the paper document to be authenticated where the neutralizer security ink has been applied;
wherein the application of the test solution to the first area results in no color change in the first area due to the neutralization of the reactant in the paper document, and application of the test solution to a second area where neutralizer security ink has not been applied results in color change in the second area due to a chemical reaction between the reactant and at least one component of the test solution.

22. The method according to claim 21, further comprising the steps of:
applying a color changing security ink to the paper document to be authenticated at least to an area where the neutralizer security ink was applied, the color changing security ink having a first security color and a second security color;
applying a test solution to the paper document to be authenticated at least on the area where the neutralizer security ink and color changing security ink have both been applied;
wherein the application of the test solution to the area where the neutralizer security ink and color changing security ink have both been applied causes the color changing security ink to change from the first security color to the second security color.

23. The method according to claim 21, wherein the neutralizer security ink comprises an ultraviolet property.

24. The method according to claim 23, wherein the ultraviolet property is effectuated by addition of an ultraviolet brightener to the neutralizer security ink.

25. The method according to claim 23, where in the ultraviolet property is effectuated by the addition of an ultraviolet absorber to the neutralizer security ink.

26. The method according to claim 21, wherein the neutralizer security ink comprises potassium phosphate.

27. The method according to claim 21, wherein the neutralizer security ink comprises sodium phosphate.

28. The method according to claim 21, wherein the neutralizer security ink comprises sodium thiosulfate.

29. The method according to claim 21, wherein the neutralizer security ink comprises a surfactant.

30. The method according to claim 21, wherein the neutralizer security ink comprises a binder agent.

31. The method according to claim 30, wherein the binder agent comprises hydroxyethyl cellulose.

32. The method according to claim 22, wherein the color changing security ink comprises bromocresol green.

33. The method according to claim 22, wherein the color changing security ink comprises bromocresol green sodium salt.

34. The method according to claim 22, wherein the color changing security ink comprises a surfactant.

35. The method according to claim 22, wherein the color changing security ink comprises a binder agent.

36. The method according to claim 35, wherein the binder agent for the color changing security ink comprises hydroxyethyl cellulose.

37. The method according to claim 22, wherein the color changing security ink comprises isopropanol.

38. The method according to claim 21, wherein the test solution comprises iodine.

39. The method according to claim 22, wherein the test solution comprises iodine and a reactant chemical that causes the color changing security ink to change from the first security color to the second security color.

40. The method according to claim 39, wherein the reactant chemical comprises tartaric acid.

41. The method according to claim 24, wherein the ultra violet brightener is present in the neutralizer security ink in an amount of up to about 2% of the total weight of the neutralizer security ink.

42. The method according to claim 21, wherein the neutralizer security ink comprises about 2.1% potassium phosphate, 2.1% sodium phosphate, 8.7% sodium thiosulfate, 0.5% surfactant, 1.7% hydroxyethyl cellulose and 84.9% water by weight of the neutralizer security ink.

43. The method according to claim 22, wherein the color changing security ink comprises about 1.3% bromocresol green, 1.3% bromocresol green sodium salt, 0.5% surfactant, 1.7% hydroxyethyl cellulose, 10% isopropanol and 85.2% water by weight of the color changing security ink.

44. A system for document authentication, comprising:
a neutralizer security ink applied on a paper document to neutralize a reactant in the paper document; and
a test solution, wherein application of the test solution to an area of the paper document where the neutralizer security ink is applied results in no color change due to the neutralization of the reactant in the paper document, and application of the test solution to an area of the paper document where no neutralizer security ink is applied results in a color change due to a chemical reaction between the reactant and at least one component of the test solution.

45. The system of claim 44, further comprising a color changing security ink applied over the neutralizer security ink on the paper document, the color changing security ink having a first security color and second security color, wherein application of the test solution to an area where color changing security ink has been applied over the neutralizer security ink causes the color changing security ink to change color from the first security color to the second security color.

46. The system of claim 44, wherein the neutralizer security ink comprises an ultraviolet property.

47. The system of claim 46, wherein the ultraviolet property is effectuated by addition of an ultraviolet brightener to the neutralizer security ink.

48. The system of claim 46, wherein the ultraviolet property is effectuated by the addition of an ultraviolet absorber to the neutralizer security ink.

49. The system of claim 44, wherein the neutralizer security ink comprises potassium phosphate.

50. The system of claim 44, wherein the neutralizer security ink comprises sodium phosphate.

51. The system of claim 44, wherein the neutralizer security ink comprises sodium thiosulfate.

52. The system of claim 44, wherein the neutralizer security ink comprises a surfactant.

53. The system of claim 44, wherein the neutralizer security ink comprises a binder agent.

54. The system of claim 53, wherein the binder agent comprises hydroxyethyl cellulose.

55. The system of claim 45, wherein the color changing security ink comprises bromocresol green.

56. The system of claim 45, wherein the color changing security ink comprises bromocresol green sodium salt.

57. The system of claim 45, wherein the color changing security ink comprises a surfactant.

58. The system of claim 45, wherein the color changing security ink comprises a binder agent.

59. The system of claim 58, wherein the binder agent for the color changing security ink comprises hydroxyethyl cellulose.

60. The system of claim 45, wherein the color changing security ink comprises isopropanol.

61. The system of claim 44, wherein the test solution comprises iodine.

62. The system of claim 45, wherein the test solution comprises iodine and a reactant chemical that causes the color changing security ink to change from the first security color to the second security color.

63. The system of claim 62, wherein the reactant chemical comprises tartaric acid.

64. The system of claim 47, wherein the ultra violet brightener is present in the neutralizer security ink in an amount of up to about 2% of the total weight of the neutralizer security ink.

65. The system of claim 44, wherein the neutralizer security ink comprises about 2.1% potassium phosphate, 2.1% sodium phosphate, 8.7% sodium thiosulfate, 0.5% surfactant, 1.7% hydroxyethyl cellulose and 84.9% water by weight of the neutralizer security ink.

66. The system of claim 45, wherein the color changing security ink comprises about 1.3% bromocresol green, 1.3% bromocresol green sodium salt, 0.5% surfactant, 1.7% hydroxyethyl cellulose, 10% isopropanol and 85.2% water by weight of the color changing security ink.

67. A method of document authentication, comprising:
applying a color changing security ink to a paper document to be authenticated, the paper document having a coating, and the color changing security ink having a first security color and a second security color;
applying a test solution to the paper document to be authenticated; and
identifying the paper document as authentic when the application of the test solution to the area where the color changing security ink has been applied causes the color changing security ink to change from the first security color to the second security color.

68. The method according to claim 67, wherein the color changing security ink comprises bromocresol green.

69. The method according to claim 67, wherein the color changing security ink comprises bromocresol green sodium salt.

70. The method according to claim 67, wherein the color changing security ink comprises a surfactant.

71. The method according to claim 67, wherein the color changing security ink comprises a binder agent.

72. The method according to claim 71, wherein the binder agent for the color changing security ink comprises hydroxyethyl cellulose.

73. The method according to claim 67, wherein the color changing security ink comprises isopropanol.

74. The method according to claim 67, wherein the test solution comprises iodine and a reactant chemical that causes the color changing security ink to change from the first security color to the second security color.

75. The method according to claim 74, wherein the reactant chemical comprises tartaric acid.

76. The method according to claim 67, wherein the color changing security ink comprises about 1.3% bromocresol green, 1.3% bromocresol green sodium salt, 0.5% surfactant, 1.7% hydroxyethyl cellulose, 10% isopropanol and 85.2% water by weight of the color changing security ink.
